(19) United States
(12) Patent Application Publication
(10) Pub. No.: US 2019/0265404 A1
(43) Pub. Date: Aug. 29, 2019

(54) OPTICAL FILM, BACKLIGHT MODULE, AND DISPLAY DEVICE

(71) Applicant: HUIZHOU CHINA STAR OPTOELECTRONICS TECHNOLOGY CO., LTD., Huizhou Guangdong (CN)

(72) Inventors: Jianyu CHANG, Huizhou Guangdong (CN); Yungjui LEE, Huizhou Guangdong (CN); Yuchun HSIAO, Huizhou Guangdong (CN); Shengjer CHANGCHIEN, Huizhou Guangdong (CN)

(21) Appl. No.: 16/152,233

(22) Filed: Oct. 4, 2018

Related U.S. Application Data
(63) Continuation of application No. PCT/CN2018/082146, filed on Apr. 8, 2018.

(30) Foreign Application Priority Data
Feb. 24, 2018 (CN) 201810157682.5

(51) Int. Cl. F21V 8/00

(52) U.S. Cl. CPC G02B 6/0051; G02F 2001/133614; G02B 6/0053

(57) ABSTRACT

The present disclosure relates to an optical film, configured on a top of a light guide plate, including: a diffusion sheet and an enhancement sheet configured on the diffusion sheet. At least one of the diffusion sheet and the enhancement sheet is doped with quantum dot (QD) material. As such, the emergent angle may be increased, and the viewing angle of the display device may be increased.

### CROSS REFERENCE TO RELATED APPLICATIONS

This application is a continuing application of PCT Patent Application No. PCT/CN2018/082146, entitled “OPTICAL FILM, BACKLIGHT MODULE, AND DISPLAY DEVICE”, filed on Apr. 8, 2018, which claims priority to Chinese Patent Application No. 201810157682.5, filed on Feb. 24, 2018, both of which are hereby incorporated in its entireties by reference.

### BACKGROUND

### 1. Technical Field

The present disclosure relates to display field, more particularly to an optical film, a backlight module, and a display device.

### 2. Description of Related Art

Backlight modules mainly includes a backlight, a light guide plate, at least one optical film, and a plastic frame. The backlight module is usually adopted in the display panel to provide a reliable light source due to the attributes, such as high brightness, long life cycle, uniform brightness. Currently, the backlight module of the liquid crystal display (LCD) mainly adopt the light-emitting diode (LED) as the light source.

Taking the side-type backlight module as an example, light beams emitted from the LED light source enter the light guide plate, and the light beams are uniformly transmitted out of the light guide plate from the mesh structure at the bottom of the light guide plate. A certain number of the optical films is arranged on the surface of the light guide plate to increase the brightness and to uniformly distribute the light beams. Such that the stain may be covered and the brightness may be increased. The optical films arranged on the surface of the light guide plate may include the enhancement sheet and the diffusion sheet in the conventional design. However, the emergent angle of the light beams may greatly be reduced after passing through the multi-layered optical films. Thus, the viewing angle of the display device may be reduced, that is, the display device may have a poor performance when viewing from the side of the display device.

Therefore, an optical film, which may be adopted in the side-type backlight module, capable of increasing the emergent angle of the backlight module and the viewing angle of the display device is required.

### SUMMARY

In one aspect, the present disclosure relates to an optical film configured on a top of a light guide plate, including: a diffusion sheet and an enhancement sheet configured on the diffusion sheet, wherein at least one of the diffusion sheet and the enhancement sheet is doped with quantum dot (QD) material.

The QD material is of a single-layer structure.

The diffusion sheet or the enhancement sheet is individually doped with the single-layered QD material, and the single-layered QD material is one of green light QD material, red light QD material, and blue light QD material.

The diffusion sheet and the enhancement sheet are both doped with the single-layered QD material, the single-layered QD material in the diffusion sheet is the same with the single-layered QD material in the enhancement sheet, and the single-layered QD material is one of green light QD material, red light QD material, and blue light QD material.

The diffusion sheet and the enhancement sheet are both doped with the single-layered QD material, the single-layered QD material in the diffusion sheet is different from the single-layered QD material in the enhancement sheet, the single-layered QD material doped in the diffusion sheet is red light QD material or blue light QD material, and the single-layered QD material doped in the enhancement sheet is green light QD material.

The QD material is of a multi-layer structure, the multi-layered QD material includes at least two layers, a bottom-layer is formed by red light QD material, and a top-layer is formed by green light QD material.

The diffusion sheet or the enhancement sheet is individually doped with the multi-layered QD material.

The diffusion sheet and the enhancement sheet are both doped with the multi-layered QD material, and the multi-layered QD material in the diffusion sheet is different from or the same with the multi-layered QD material in the enhancement sheet.

The present disclosure further relates to a backlight module, including: at least one optical film configured on a top of a light guide plate, wherein the optical film includes: a diffusion sheet and an enhancement sheet configured on the diffusion sheet, wherein at least one of the diffusion sheet and the enhancement sheet is doped with QD material.

The QD material is of a single-layer structure.

The diffusion sheet or the enhancement sheet is individually doped with the single-layered QD material, and the single-layered QD material is one of green light QD material, red light QD material, and blue light QD material.

The diffusion sheet and the enhancement sheet are both doped with the single-layered QD material, the single-layered QD material in the diffusion sheet is the same with the single-layered QD material in the enhancement sheet, and the single-layered QD material is one of green light QD material, red light QD material, and blue light QD material.

The diffusion sheet and the enhancement sheet are both doped with the single-layered QD material, the single-layered QD material in the diffusion sheet is different from the single-layered QD material in the enhancement sheet, the single-layered QD material doped in the diffusion sheet is red light QD material or blue light QD material, and the single-layered QD material doped in the enhancement sheet is green light QD material.

The QD material is of a multi-layer structure, the multi-layered QD material includes at least two layers, a bottom-layer is formed by red light QD material, and a top-layer is formed by green light QD material.

The diffusion sheet or the enhancement sheet is individually doped with the multi-layered QD material.

The diffusion sheet and the enhancement sheet are both doped with the multi-layered QD material, and the multi-layered QD material in the diffusion sheet is different from or the same with the multi-layered QD material in the enhancement sheet.

The present disclosure further relates to a display device, including a backlight module including at least one optical film configured on a top of a light guide plate, wherein the optical film includes: a diffusion sheet and an enhancement sheet configured on the diffusion sheet, wherein at least one of the diffusion sheet and the enhancement sheet is doped with QD material.

The QD material is of a single-layer structure, the diffusion sheet or the enhancement sheet is individually doped with the single-layered QD material, and the single-layered QD material is one of green light QD material, red light QD material, and blue light QD material.

The QD material is of a single-layer structure, wherein the diffusion sheet and the enhancement sheet are both doped with the single-layered QD material, the single-layered QD material in the diffusion sheet is the same with the single-layered QD material in the enhancement sheet, and the single-layered QD material is one of green light QD material, red light QD material, and blue light QD material.

The diffusion sheet and the enhancement sheet are both doped with the single-layered QD material, the single-layered QD material in the diffusion sheet is different from the single-layered QD material in the enhancement sheet, the single-layered QD material doped in the diffusion sheet is red light QD material or blue light QD material, and the single-layered QD material doped in the enhancement sheet is green light QD material.

In view of the above, the QD material is doped in the diffusion sheet and/or the enhancement sheet. The QD material has a high conversion rate with respect to light and an excellent scattering performance. As such, when the backlight adopts the optical film doped with the QD material, the brightness may be improved, the emergent angle may be increased, and the viewing angle of the display device may be increased.

### BRIEF DESCRIPTION OF THE DRAWINGS

FIG. 1 is a schematic view of an optical film in accordance with one embodiment of the present disclosure.

FIG. 2 is a schematic view of an optical film in accordance with another embodiment of the present disclosure.

FIG. 3 is a schematic view of an optical film in accordance with another embodiment of the present disclosure

FIG. 4 is a schematic view of an optical film in accordance with another embodiment of the present disclosure.

FIG. 5 is a schematic view of an optical film in accordance with another embodiment of the present disclosure.

FIG. 6 is a schematic view of an optical film in accordance with another embodiment of the present disclosure.

FIG. 7 is a schematic view of an optical film in accordance with another embodiment of the present disclosure.

FIG. 8 is a schematic view of an optical film in accordance with another embodiment of the present disclosure.

FIG. 9 is a schematic view of an optical film in accordance with another embodiment of the present disclosure.

### DETAILED DESCRIPTION

To clarify the purpose, technical solutions, and the advantages of the disclosure, embodiments of the invention will now be described more fully hereinafter with reference to the accompanying drawings.

Quantum dot (QD) may enter an excited state when receiving light, and may emit light beams with a specific wavelength, i.e., a specific color, when returning to a ground state from the excited state. The emission spectrum of the QD is mainly controlled by particle size of the QD. That is, the emission spectrum of the QD may be adjusted by changing the particle size of the QD. The QD has a high conversion efficiency, and a high utilization rate with respect to the light. A half wave width of the emission spectrum of the QD is narrow, and a temperature stability of the QD and a scattering performance with respect to the light is excellent. Therefore, when a conventional optical film doped with the QD material is adopted in a backlight module, brightness may be improved, and viewing angle may be increased.

A new optical film is provided. The different QD material may respectively be doped in each layer of the conventional optical film, or the different QD material may be doped in one layer of the conventional optical film. As such, emergent angle of the backlight module and the viewing angle of the display device may be increased.

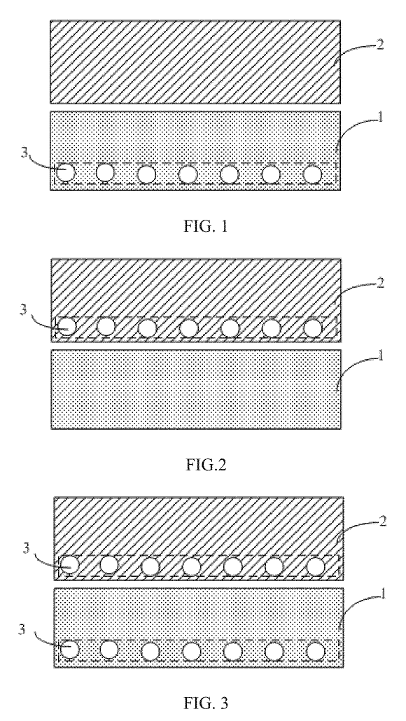

As shown in FIG. 1, the present disclosure relates to an optical film configured on a top of a light guide plate. The optical film may include a diffusion sheet 1 and an enhancement sheet 2 configured on the diffusion sheet 1. The diffusion sheet 1 is individually doped with QD material 3.

The QD material 3 is of a single-layer structure, and the individual single-layered QD material doped in the diffusion sheet 1 may be one of green light QD material, red light QD material, and blue light QD material.

As shown in FIG. 2, the present disclosure further relates to another optical film configured on the top of the light guide plate. The optical film may include the diffusion sheet 1 and the enhancement sheet 2 configured on the diffusion sheet 1. The enhancement sheet 2 is individually doped with QD material 3.

The QD material 3 is of the single-layer structure, and the individual single-layered QD material doped in the enhancement sheet 2 may be one of the green light QD material, the red light QD material, and the blue light QD material.

As shown in FIG. 3, the present disclosure further relates to another optical film configured on the top of the light guide plate. The optical film may include the diffusion sheet 1 and the enhancement sheet 2 configured on the diffusion sheet 1. The diffusion sheet land the enhancement sheet 2 are both doped with QD material 3.

The QD material 3 is of the single-layer structure. The single-layered QD material 3 doped in the diffusion sheet 1 is the same with the single-layered QD material 3 doped in the enhancement sheet 2. The single-layered QD material may be one of the green light QD material, the red light QD material, and the blue light QD material.

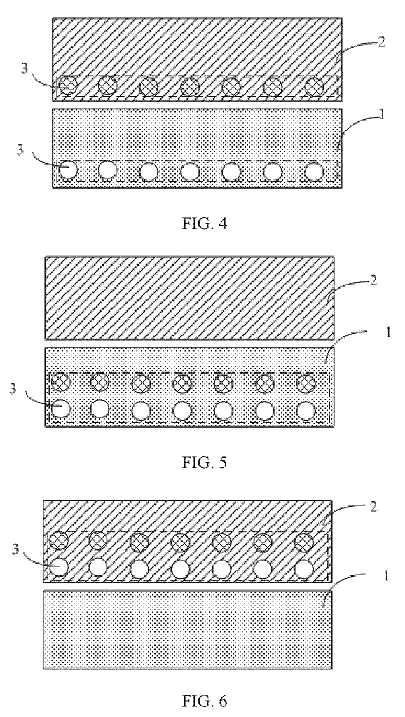

As shown in FIG. 4, the present disclosure further relates to another optical film configured on the top of the light guide plate. The optical film may include the diffusion sheet 1 and the enhancement sheet 2 configured on the diffusion sheet 1. The diffusion sheet land the enhancement sheet 2 are both doped with QD material 3.

The QD material 3 is of the single-layer structure. The single-layered QD material 3 doped in the diffusion sheet 1 is different from the single-layered QD material 3 doped in the enhancement sheet 2. The single-layered QD material doped in the diffusion sheet 1 is configured to be the red light QD material or the blue light QD material. The single-layered QD material doped in the enhancement sheet 2 is configured to be the green light QD material (represented by balls with crosslines shown in FIG. 4).

It is noted that green light is easily absorbed by the red light QD material to excite the red light QD material to emit red light, which may result in a non-uniform color distribution of emitting light and a non-uniform image. Therefore, in order to reduce secondary absorption of the green light, it is necessary to configure the green light QD material on one side of the light guide plate to face away a light emission side of the light guide plate.

As shown in FIG. 5, the present disclosure further relates to another optical film configured on the top of the light guide plate. The optical film may include the diffusion sheet 1 and the enhancement sheet 2 configured on the diffusion sheet 1. The diffusion sheet 1 is individually doped with QD material 3.

The QD material 3 is of a multi-layer structure. The multi-layered QD material 3 doped in the diffusion sheet 1 may include at least two layers. A bottom-layer is formed by the red light QD material (represented by blank balls shown in FIG. 5), and a top-layer is formed by the green light QD material (represented by the balls with crosslines shown in FIG. 5).

It is noted that a middle layer of the multi-layered QD material 3 may be empty, or may be formed by one of the green light QD material, the red light QD material, and the blue light QD material, or may be a multi-layered structure formed by stacking at least two of the green light QD material, the red light QD material, and the blue light QD material.

As shown in FIG. 6, the present disclosure further relates to another optical film configured on the top of the light guide plate. The optical film may include the diffusion sheet 1 and the enhancement sheet 2 configured on the diffusion sheet 1. The enhancement sheet 2 is individually doped with QD material 3.

The QD material 3 is of the multi-layer structure. The multi-layered QD material 3 doped in the enhancement sheet 2 may include at least two layers. The bottom-layer is formed by the red light QD material (represented by the blank balls shown in FIG. 6), and the top-layer is formed by the green light QD material (represented by the balls with crosslines shown in FIG. 6).

It is noted that the middle layer of the multi-layered QD material 3 may be empty, or may be formed by one of the green light QD material, the red light QD material, and the blue light QD material, or may be the multi-layered structure formed by stacking the at least two of the green light QD material, the red light QD material, and the blue light QD material.

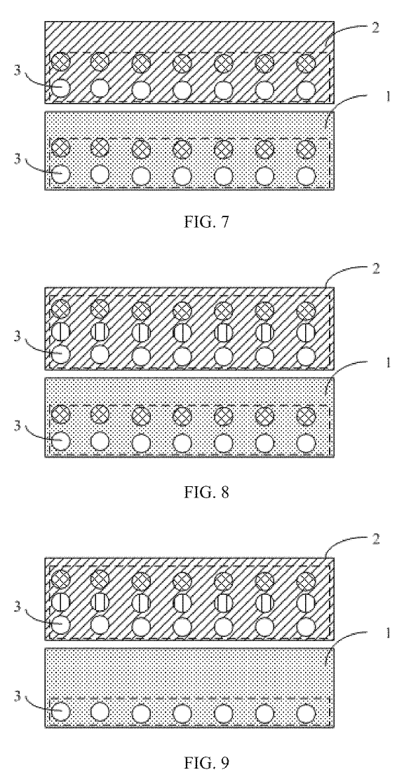

As shown in FIG. 7, the present disclosure further relates to another optical film configured on the top of the light guide plate. The optical film may include the diffusion sheet 1 and the enhancement sheet 2 configured on the diffusion sheet 1. The diffusion sheet land the enhancement sheet 2 are both doped with QD material 3.

The QD material 3 is of the multi-layer structure. The multi-layered QD material 3 doped in the diffusion sheet 1 is the same with the multi-layered QD material 3 doped in the enhancement sheet 2. The multi-layered QD material 3 may include at least two layers. The bottom-layer is formed by the red light QD material (represented by the blank balls shown in FIG. 7), and the top-layer is formed by the green light QD material (represented by the balls with crosslines shown in FIG. 7).

It is noted that the middle layer of the multi-layered QD material 3 may be empty, or may be formed by one of the green light QD material, the red light QD material, and the blue light QD material, or may be the multi-layered structure formed by stacking the at least two of the green light QD material, the red light QD material, and the blue light QD material.

As shown in FIG. 8, the present disclosure further relates to another optical film configured on the top of the light guide plate. The optical film may include the diffusion sheet 1 and the enhancement sheet 2 configured on the diffusion sheet 1. The diffusion sheet land the enhancement sheet 2 are both doped with QD material 3.

The QD material 3 is of the multi-layer structure. The multi-layered QD material 3 doped in the diffusion sheet 1 is different from the multi-layered QD material 3 doped in the enhancement sheet 2. The multi-layered QD material 3 may include at least two layers. The bottom-layer is formed by the red light QD material (represented by the blank balls shown in FIG. 8), and the top-layer is formed by the green light QD material (represented by the balls with crosslines shown in FIG. 8).

As shown in FIG. 8, the QD material 3 in the diffusion sheet 1 includes two layers, and the QD material 3 in the enhancement sheet 2 includes three layers, which includes the bottom-layer formed by the red light QD material (represented by the blank balls shown in FIG. 8), the top-layer formed by the green light QD material (represented by the balls with crosslines shown in FIG. 8), and the middle-layer formed by the blue light QD material (represented by balls with vertical lines shown in FIG. 8).

It is noted that the middle layer of the multi-layered QD material 3 may be empty, or may be formed by one of the green light QD material, the red light QD material, and the blue light QD material, or may be the multi-layered structure formed by stacking the at least two of the green light QD material, the red light QD material, and the blue light QD material.

As shown in FIG. 9, the present disclosure further relates to another optical film configured on the top of the light guide plate. The optical film may include the diffusion sheet 1 and the enhancement sheet 2 configured on the diffusion sheet 1. The diffusion sheet land the enhancement sheet 2 are both doped with QD material 3.

In one example, the QD material 3 in the diffusion sheet 1 is of the single-layer structure, and the QD material 3 in the enhancement sheet 2 is of the multi-layer structure. The multi-layered QD material 3 doped in the diffusion sheet 1 is different from the multi-layered QD material 3 doped in the enhancement sheet 2. In another example, the QD material 3 in the diffusion sheet 1 is of the multi-layer structure, and the QD material 3 in the enhancement sheet 2 is of the single-layer structure.

The multi-layered QD material 3 may include at least two layers. The bottom-layer is formed by the red light QD material (represented by the blank balls shown in FIG. 9), and the top-layer is formed by the green light QD material (represented by the balls with crosslines shown in FIG. 9).

It is noted that the middle layer of the multi-layered QD material 3 may be empty, or may be formed by one of the green light QD material, the red light QD material, and the blue light QD material, or may be the multi-layered structure formed by stacking the at least two of the green light QD material, the red light QD material, and the blue light QD material.

The present disclosure further relates to a backlight module, including one of the optical films described above. The optical film in the backlight module has the same structure with one of the optical films described above, and the detail description of the optical film may not be described again.

The present disclosure further relates to a display device, including the backlight module described above. The backlight module in the display device has the same structure with the backlight module described above, and the detail description may not be described again.

In view of the above, the QD material is doped in the diffusion sheet and/or the enhancement sheet. The QD material has a high conversion rate with respect to light and an excellent scattering performance. As such, when the backlight adopts the optical film doped with the QD material, the brightness may be improved, the emergent angle may be increased, and the viewing angle of the display device may be increased.

The figure and the embodiment described according to figure are only for illustration, and the present disclosure is not limited to these embodiments. All other embodiments obtained by a person of ordinary skill in the art based on the embodiments of the present disclosure without creative efforts shall fall within the protection scope of the present disclosure.

What is claimed is:

1. An optical film configured on a top of a light guide plate, comprising:
a diffusion sheet and an enhancement sheet configured on the diffusion sheet, wherein at least one of the diffusion sheet and the enhancement sheet is doped with quantum dot (QD) material.

2. The optical film according to claim 1, wherein the QD material is of a single-layer structure.

3. The optical film according to claim 2, wherein the diffusion sheet or the enhancement sheet is individually doped with the single-layered QD material, and the single-layered QD material is one of green light QD material, red light QD material, and blue light QD material.

4. The optical film according to claim 2, wherein the diffusion sheet and the enhancement sheet are both doped with the single-layered QD material, the single-layered QD material in the diffusion sheet is the same with the single-layered QD material in the enhancement sheet, and the single-layered QD material is one of green light QD material, red light QD material, and blue light QD material.

5. The optical film according to claim 2, wherein the diffusion sheet and the enhancement sheet are both doped with the single-layered QD material, the single-layered QD material in the diffusion sheet is different from the single-layered QD material in the enhancement sheet, the single-layered QD material doped in the diffusion sheet is red light QD material or blue light QD material, and the single-layered QD material doped in the enhancement sheet is green light QD material.

6. The optical film according to claim 1, wherein the QD material is of a multi-layer structure, the multi-layered QD material comprises at least two layers, a bottom-layer is formed by red light QD material, and a top-layer is formed by green light QD material.

7. The optical film according to claim 6, wherein the diffusion sheet or the enhancement sheet is individually doped with the multi-layered QD material.

8. The optical film according to claim 6, wherein the diffusion sheet and the enhancement sheet are both doped with the multi-layered QD material, and the multi-layered QD material in the diffusion sheet is different from or the same with the multi-layered QD material in the enhancement sheet.

9. A backlight module, comprising:
at least one optical film configured on a top of a light guide plate, wherein the optical film comprises:
a diffusion sheet and an enhancement sheet configured on the diffusion sheet, wherein at least one of the diffusion sheet and the enhancement sheet is doped with QD material.

10. The backlight module according to claim 9, wherein the QD material is of a single-layer structure.

11. The backlight module according to claim 10, wherein the diffusion sheet or the enhancement sheet is individually doped with the single-layered QD material, and the single-layered QD material is one of green light QD material, red light QD material, and blue light QD material.

12. The backlight module according to claim 10, wherein the diffusion sheet and the enhancement sheet are both doped with the single-layered QD material, the single-layered QD material in the diffusion sheet is the same with the single-layered QD material in the enhancement sheet, and the single-layered QD material is one of green light QD material, red light QD material, and blue light QD material.

13. The backlight module according to claim 10, wherein the diffusion sheet and the enhancement sheet are both doped with the single-layered QD material, the single-layered QD material in the diffusion sheet is different from the single-layered QD material in the enhancement sheet, the single-layered QD material doped in the diffusion sheet is red light QD material or blue light QD material, and the single-layered QD material doped in the enhancement sheet is green light QD material.

14. The backlight module according to claim 9, wherein the QD material is of a multi-layer structure, the multi-layered QD material comprises at least two layers, a bottom-layer is formed by red light QD material, and a top-layer is formed by green light QD material.

15. The backlight module according to claim 14, wherein the diffusion sheet or the enhancement sheet is individually doped with the multi-layered QD material.

16. The backlight module according to claim 14, wherein the diffusion sheet and the enhancement sheet are both doped with the multi-layered QD material, and the multi-layered QD material in the diffusion sheet is different from or the same with the multi-layered QD material in the enhancement sheet.

17. A display device, comprising:
a backlight module comprising at least one optical film configured on a top of a light guide plate, wherein the optical film comprises:
a diffusion sheet and an enhancement sheet configured on the diffusion sheet, wherein at least one of the diffusion sheet and the enhancement sheet is doped with QD material.

18. The display device according to claim 17, wherein the QD material is of a single-layer structure, the diffusion sheet or the enhancement sheet is individually doped with the single-layered QD material, and the single-layered QD material is one of green light QD material, red light QD material, and blue light QD material.

19. The display device according to claim 17, wherein the QD material is of a single-layer structure, wherein the diffusion sheet and the enhancement sheet are both doped with the single-layered QD material, the single-layered QD material in the diffusion sheet is the same with the single-layered QD material in the enhancement sheet, and the single-layered QD material is one of green light QD material, red light QD material, and blue light QD material.

20. The display device according to claim 17, wherein the diffusion sheet and the enhancement sheet are both doped with the single-layered QD material, the single-layered QD material in the diffusion sheet is different from the single-layered QD material in the enhancement sheet, the single-layered QD material doped in the diffusion sheet is red light QD material or blue light QD material, and the single-layered QD material doped in the enhancement sheet is green light QD material.
